(19) United States
(12) Patent Application Publication
(10) Pub. No.: US 2021/0097771 A1
(43) Pub. Date: Apr. 1, 2021

(54) SYSTEM AND RECORDING MEDIA THEREOF FOR USING AR TECHNOLOGY COMBINES HAND-CREATING ELEMENTS TO PRODUCING VIDEO WORKS

(71) Applicant: OVER PARADIGM TECHNOLOGY INC., Kaohsiung City (TW)

(72) Inventors: Pei-Wei CHYAU, Kaohsiung City (TW); Shih-Yun CHIU, Kaohsiung City (TW); Yu-Chun LIN, Kaohsiung City (TW)

(73) Assignee: Over Paradigm Technology Inc.

(21) Appl. No.: 17/122,257

(22) Filed: Dec. 15, 2020

Related U.S. Application Data
(63) Continuation-in-part of application No. 16/101,991, filed on Aug. 13, 2018, now abandoned.

(30) Foreign Application Priority Data
Aug. 14, 2017 (TW) 106127421

(51) Int. Cl. G06T 19/00; G06T 17/10; G09B 11/00; G06F 3/0483

(52) U.S. Cl. CPC G06T 19/006; G06F 3/0483; G09B 11/00; G06T 17/10

(57) ABSTRACT

A system that combines augmented reality (AR) technology with self-created elements to produce video works and a media storing the same are revealed. The system includes a data module used for storing software drawing templates and software scenes, an image input module that reads a physical image of a physical picture book and defines a software image border, a recognition and analysis module that compares the software drawing template with the software image border to get software drawn content, and an integration module that integrates the software drawn content and the software scene for generating a self-created AR work. Thereby users can use the system to create AR video works with self-created elements in a real-time manner.

### BACKGROUND OF THE INVENTION

### 1. Technical Field

The present invention relates to a system that combines AR technology with self-created elements to produce video works and a media storing the same, especially to a system that combines AR technology with self-created elements to produce video works and a media storing the same that are applied to games or teaching materials for children.

### 2. Description of Related Art

Owing to parental involvement in children's education, more and more computer-assisted instruction (CAI) programs have been developed to meet significantly growing market demands every year. According to the survey, computer has become one of the top three things parents want their children to learn, just behind language and music. In near future, learning software for kids plays a vital role in children's education, no matter viewed from the demand side or the supply side.

The augmented reality (AR) technology for education is going to be the technology of the future, not only changes the market rules but also have wide applications. The AR can connect the real word to visual images directly or indirectly. The smart phones connected to internet and the mobile devices provided with cameras contribute to the growth of AR.

Now there are interactive motion-sensing games and teaching materials produced by augmented reality (AR) technology available on the market. AR images are generated through learning flash cards and displayed in an interesting and interactive way to help children concentrate on their learning. Thus the teaching materials are both entertaining and educational. However, most of these AR materials are single-mode, such as pure voice/pattern recognition/scanning Children are unable to create their own patterns or speeches and then integrate their works with AR images to create AR animations. Thus AR teaching materials have great potential in inspiring and conveying kids' creativity.

### SUMMARY OF THE INVENTION

Therefore it is a primary object of the present invention to provide a system that combines AR technology with self-created elements to produce video works, which uses users' self-created element to form AR video works in a real-time manner.

In order to achieve the above object, a system that combines AR technology with self-created elements to produce video works according to the present invention is executed in an electronic computer system and is composed of a data module used for storage of at least one software drawing template and at least one software scene, an image input module that reads a physical image corresponding to at least one physical character of a physical picture book and defines a software image border of the physical image, a recognition and analysis module that generates software drawn content by comparison of the software drawing template with the software image border, and an integration module that fills the software drawn content into the software drawing template correspondingly for generating an AR object and integrates the AR object with the software scene for generating a self-created AR work.

It is another object of the present invention to provide a non-transitory computer-readable medium used for storing the system that combines AR technology with self-created elements to produce video works mentioned above.

Implementation of the present invention at least produces the following advantageous effects:

1. The self-created AR works containing self-created elements are created by users themselves.
2. The self-created AR works are produced in a real-time manner.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing an embodiment in use according to the present invention;

FIG. 2 is a block diagram showing structure of an embodiment according to the present invention;

FIG. 3 is a schematic drawing showing a physical picture book applied to an embodiment according to the present invention;

FIG. 3A is schematic drawing showing sketches in the creative area of a physical picture book;

FIG. 3B is schematic drawing showing drawings in the creative area of a physical picture book;

FIG. 3C is schematic drawing showing multiple media in the creative area of a physical picture book;

FIG. 4 is a schematic drawing showing a software drawing template of an embodiment displayed on a computer screen according to the present invention;

FIG. 5A is a schematic drawing showing a physical image of a physical character of a physical picture book according to the present invention;

FIG. 5B is a schematic drawing showing software drawn content created by a recognition and analysis module according to the present invention;

FIG. 6A is a schematic drawing showing a physical character with recognition points of a physical picture book according to the present invention;

FIG. 6B is a schematic drawing showing an image generated from the embodiment in FIG. 6A according to the present invention;

FIG. 6C is a schematic drawing showing software drawn content completed by recognition points of an embodiment according to the present invention;

FIG. 6D is schematic drawing showing an AR work based on FIG. 3D;

FIG. 6E is schematic drawing showing an AR work based on FIG. 3E;

FIG. 6F is schematic drawing showing an AR work based on FIG. 3F;

FIG. 7 is a schematic drawing showing software drawn content integrated with a software drawing template of an embodiment according to the present invention;

FIG. 8 is a block diagram showing an embodiment integrated by HTML technology according to the present invention; and

FIG. 9 is a block diagram showing structure of an embodiment further having an electronic book generating module according to the present invention.

### DETAILED DESCRIPTION OF THE INVENTION

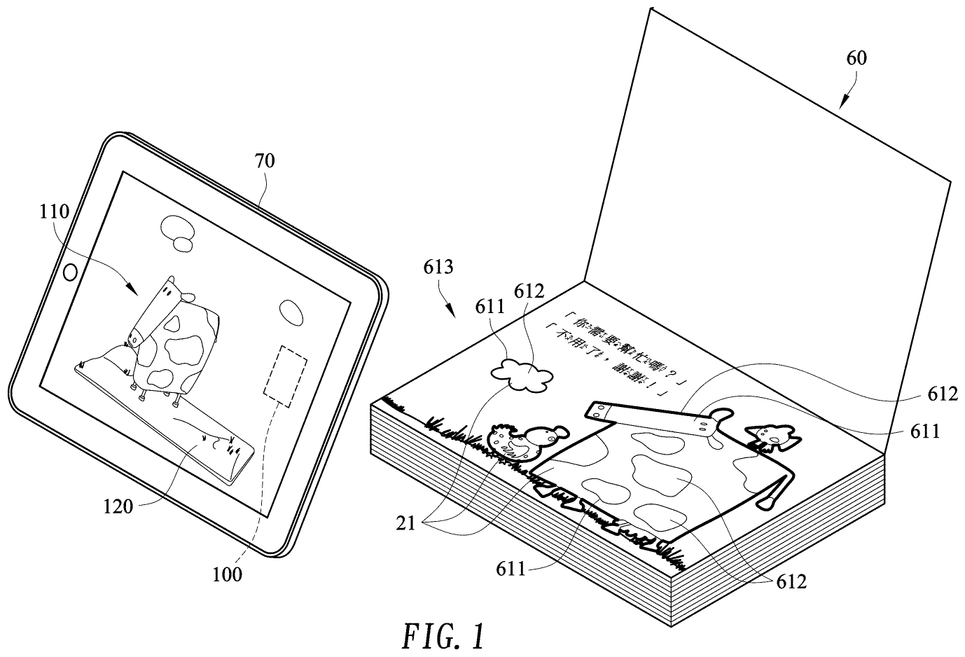

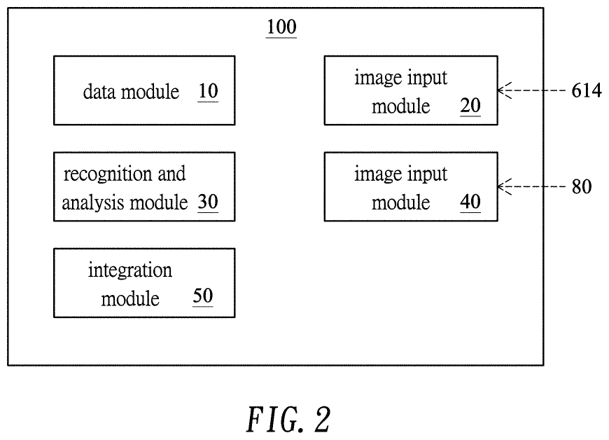

Refer to FIG. 1 and FIG. 2, a system which combines AR technology with self-created elements to produce video works 100 according to the present invention includes a data module 10, an image input module 20, a recognition and analysis module 30, a voice input module 40, and an integration module 50. The system which combines AR technology with self-created elements to produce video works 100 can be a software system executed in an electronic computer system 70 such as a mobile phone, a personal digital assistance, a computer, etc. The video works produced can be 2-dimensional (2D) or 3-dimensional (3D).

While in use, besides the software used for executing the present system that produces video works 100, a teaching aid such as a physical picture book 60, a flash card, a jigsaw puzzle, etc. is also used. The physical picture book 60 can be an AR book formed by a plurality of contiguous pages.

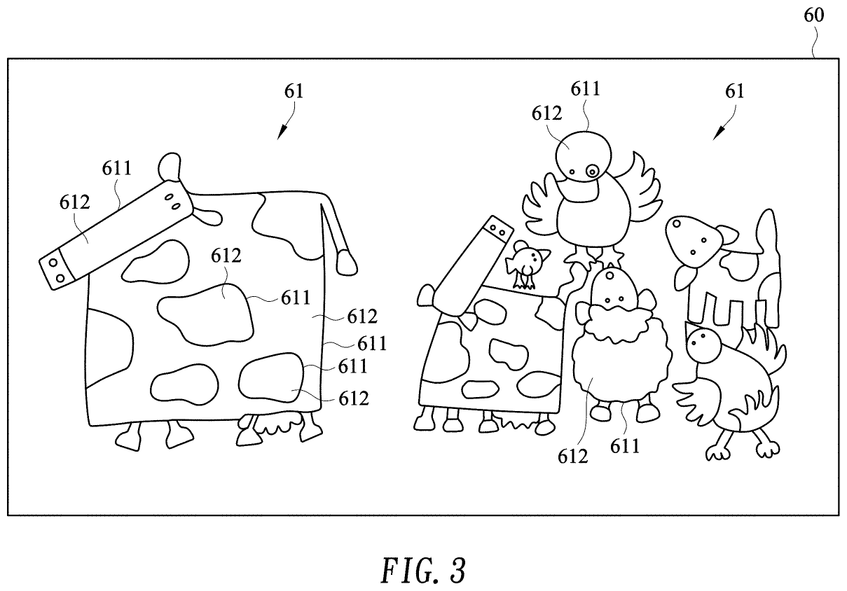

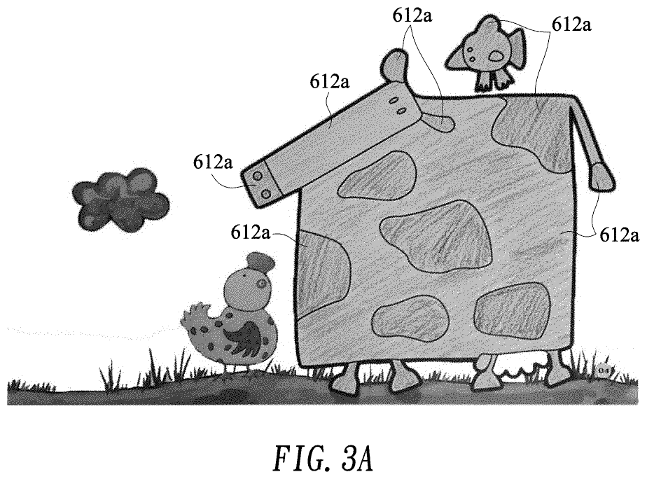

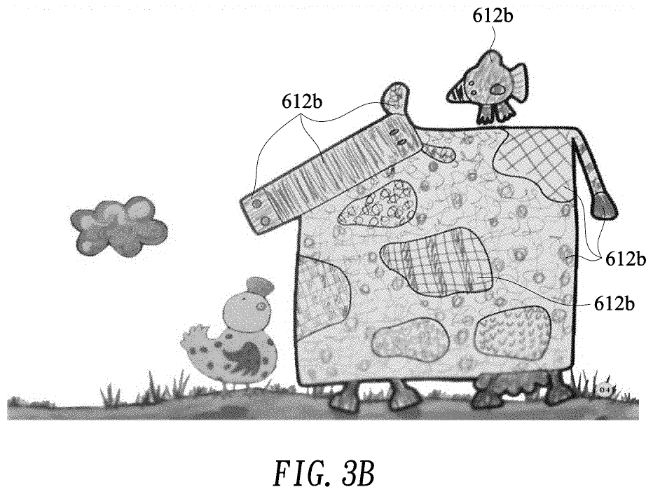

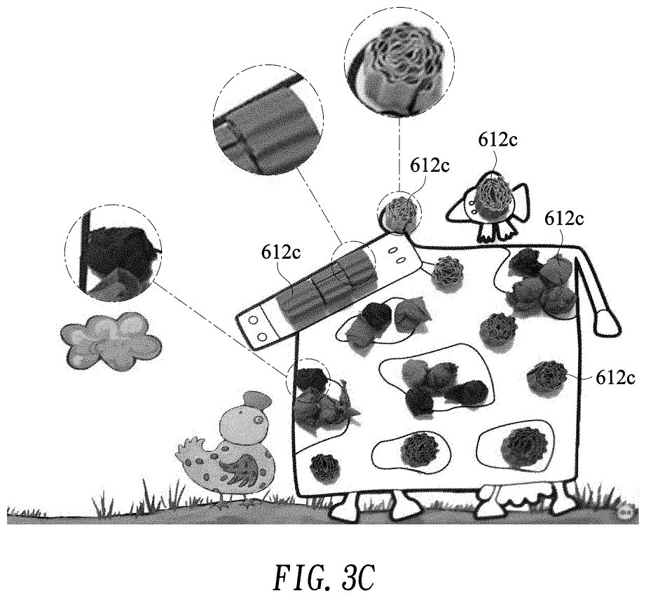

As shown in FIG. 1, 2, and FIG. 3, each page of the physical picture book 60 is designed to include at least one physical character 61 such as an animal, a person, a bird, etc. At least a part of these physical characters 61 includes a physical border 611 and a creative area 612 inside the physical border 611. Thereby kinds can create their own designs in the creative area 612 easily.

As shown in FIG. 3A, FIG. 3B, and FIG. 3C, in the creative area 612, children can make at least one sketch 612a, at least one drawing 612b, or add at least one 3D shape multiple medium element such as origami, paper rolls, cotton, wool, sequins 612c . . . to make the finished creation more rich and vivid.

Each page of the physical picture book 60 also has a physical scene 613. The arrangement of the above physical character 61 and the physical scene 613 in the respective page or the whole physical picture book 60 forms a script of a story-unit or a story script.

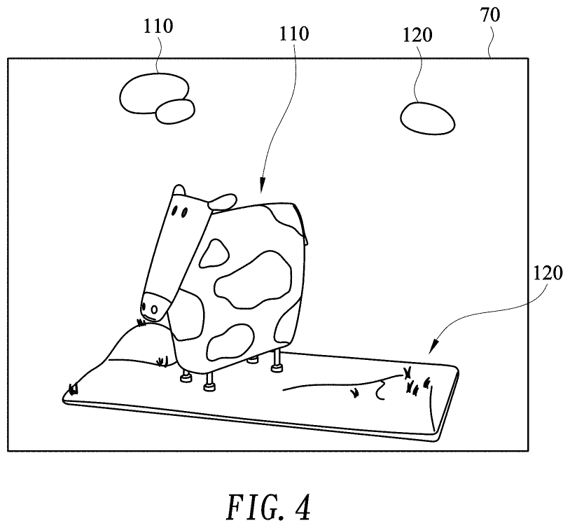

As shown in FIG. 2 and FIG. 4, the data module 10 is used to store at least one software drawing template 110 and at least one software 2D/3D scene 120. The software drawing template 110 is to convert the physical border 611 of the physical character 61 in the physical picture book 60 into the software drawing template 110 and store the software drawing template 110 in the data module 10, so that it can be produced by Augmented Reality (AR) technology in the future. The software drawing template 110 is a 2D/3D character or object represented only by lines. For coherence of the story, the software 2D/3D scene 120 is generated based on the physical picture book 60. That means the physical scene 613 of the physical picture book 60 is converted into the software 2D/3D scene 120 by AR technology.

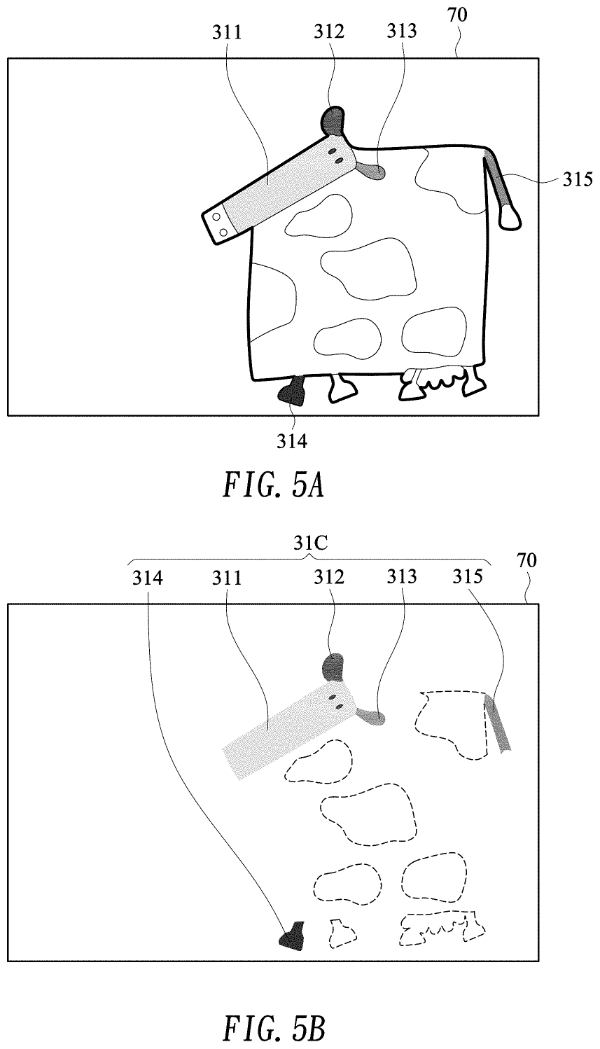

As shown in FIG. 2 and FIG. 5A, the image input module 20 is used to read a physical image 4 corresponding to the physical character 61 of the physical picture book 60. The physical image 614 is a pattern located on the creative area 612 of the physical character 61 of the physical picture book 60, created by kids and captured by a camera.

The way the image input module 20 reads the physical image 614 by using a camera to catch real-time images or read an image file. After the physical image 614 being read, define the physical border 611 of the physical image 614 by software technology, then the physical border 611 is converted into a software image border and stored in a storage unit of the computer, so that the software image border can be produced by Augmented Reality (AR) technology in the future.

As shown in FIG. 2 and FIG. 5B, after the software image border being defined, the recognition and analysis module 30 finds out software drawn content 31C inside the software image border. For example, the software drawn content 31C includes a first creative color 311, a second creative color 312, a third creative color 313 . . . and a n^{th} creative color 31n, etc. Moreover, the software drawn content 31C of other parts with dotted physical border in the FIG. 5B can also be found out by the above way. The software drawn content 31C is also stored in a storage unit of the computer, so that it can be produced by Augmented Reality (AR) technology in the future.

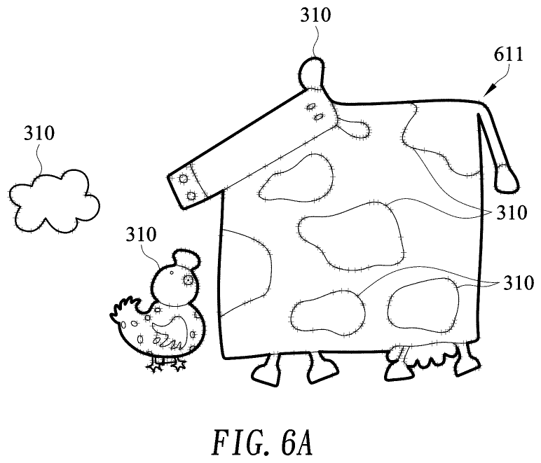

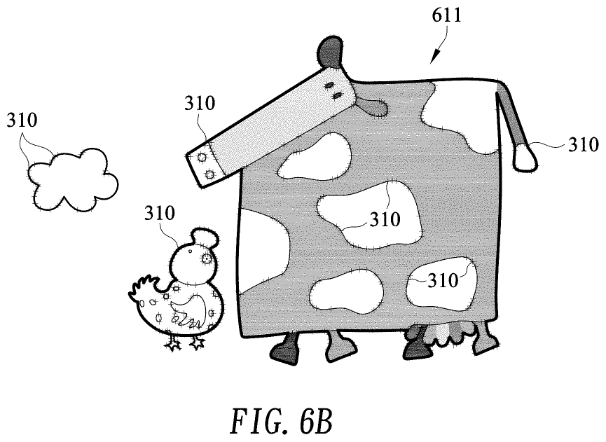

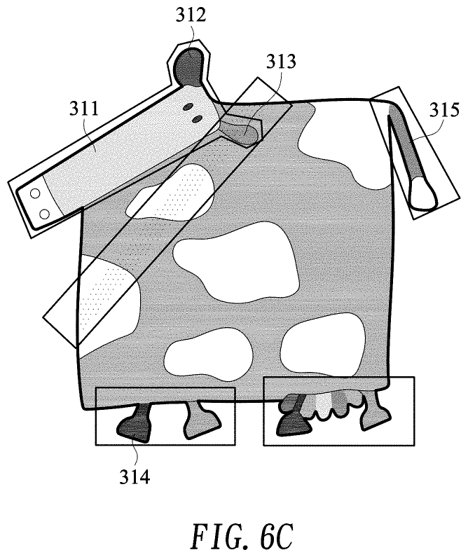

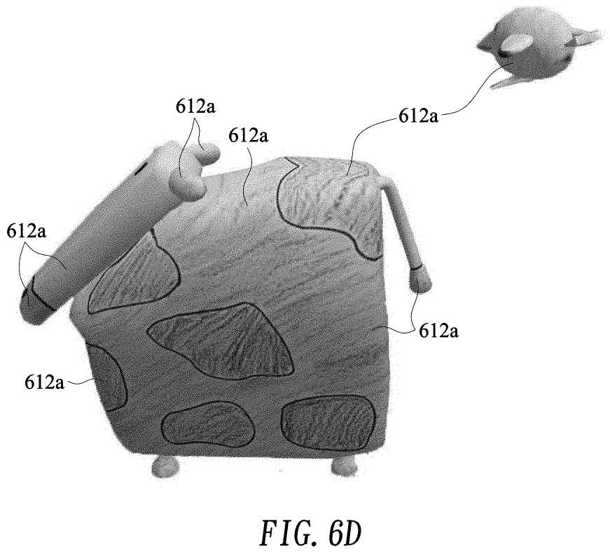

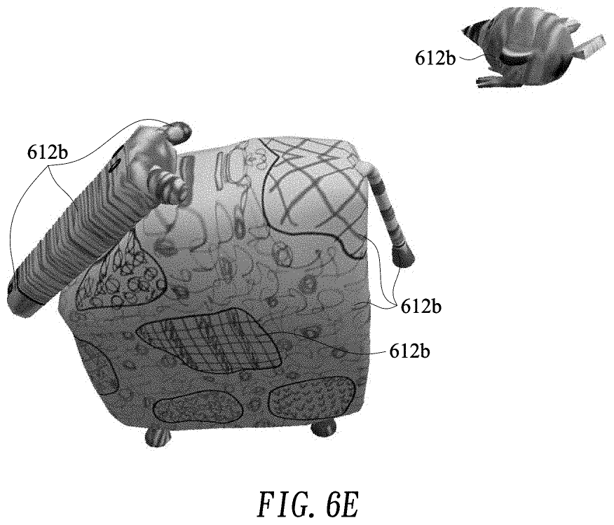

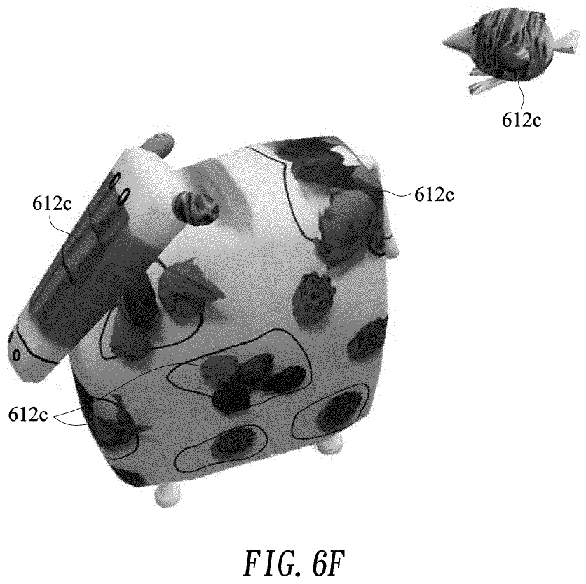

Refer to FIG. 6A-6C, the recognition and analysis module 30 compares the software drawing template 110 with the software image border so that the software drawn content 31C obtained from the respective physical character 61 corresponds to the corresponding software drawing template 110 stored in the data module 10.

As shown in FIG. 6D, FIG. 6E, and FIG. 6F, they are AR works which are based on the FIG. 3A, FIG. 3B, and FIG. 3C, respectively, and generate by using AR technology. The diversified media materials make AR works richer and more vivid to make 2D/3D characters with Augmented Reality technology.

Besides the above corresponding methods, in order to make the comparison of the recognition and analysis module 30 more easy and convenient, a plurality of recognition points 310 is further but not necessary arranged at the software drawing template 110 and the physical character 61 respectively and correspondingly in advance. By the recognition point 310, the position marked “x” on the physical border 611 or the software drawing template 110, more detailed features of the respective physical character 61 such as head, eyes, tail, even different spots on the skin can be recognized more precisely and accurately.

For easy operation of the system, the file name of the software drawn content 31C is defined by a user account, a page number of the physical picture book 60, a serial number of the character of the physical picture book 60, an edition number being drawn, or their combinations while saving the software drawn content 31C.

The voice input module 40 reads a kid's real-time speech by a PDA microphone to produce voice content 80. Moreover, the voice input module 40 can also read an audio file recorded in advance. For convenient operation of the system, the file name of the voice content 80 is defined by a user account, a page number of the physical picture book 60, a serial number of the character of the physical picture book 60, an edition number being drawn, or their combinations while saving the voice content 80.

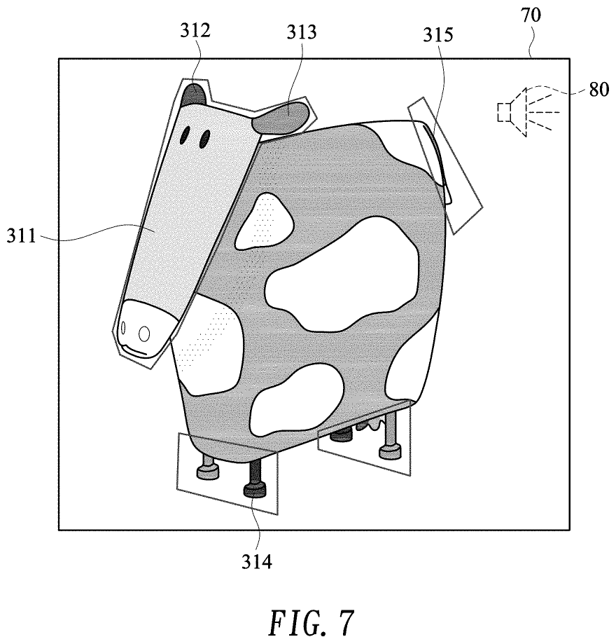

As shown in FIG. 7, the integration module 50 is used to integrate the self-created software drawn content 31C recognized, the voice content 80 created, and the software 2D/3D scene 120 built-in the electronic computer by using AR technology. During operation, the integration module 50 can define the respective page of the physical picture book 60 and create a 2D/3D model of the software drawn content 31C corresponding to the respective page by AR technology. Then the 2D/3D model is applied to the software 2D/3D scene 120 for providing dynamic effects and the voice content 80 is integrated with the respective page correspondingly. Thus a self-created 2D/3D AR work is produced.

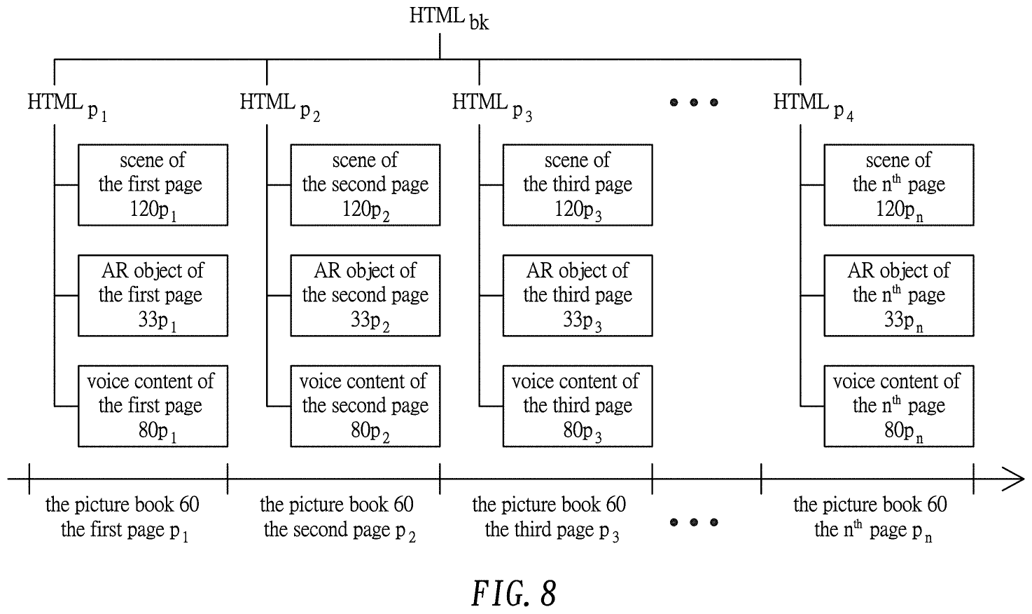

As shown in FIG. 8, a scene, a character, a speech, etc. on a page of a book is integrated by the above system to form a self-created 2D/3D AR work. During the integration process, HTML (Hypertext Markup Language) can be used to integrate the scene, the character, the speech, and so on.

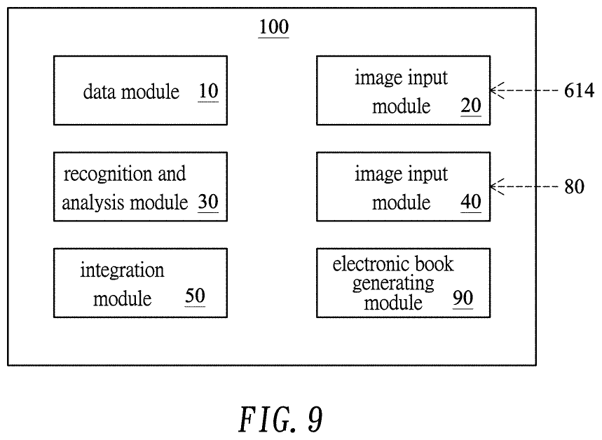

Refer to FIG. 9, another embodiment of a system that produces video works 100 according to the present invention is revealed. This embodiment further includes an electronic book generating module 90 that uses the software drawn content 31C and the voice content 80 generated to construct a script for an electronic book based on the physical picture book 60 with multiple stories on the respective page. Then the software drawn content 31C and the voice content 80 corresponding to the respective page of the electronic book script together with a plurality of components predefined as the software scene are processed by AR technology to form a 2D/3D AR page of the respective page. Next these 2D/3D AR pages are connected to form a 2D/3D AR e-book with audio formats and simple page flip effect.

In other words, the electronic book generating module 90 converts each page of the physical picture book 60 into a HTML file. For example, the first page of the physical picture book 60 is converted into a HTML_{P1} file, the second page is converted into a HTML_{P2} file, the third page is converted into a HTML_{P3} file . . . and the n^{th} page is converted into a HTML_{Pn} file. Lastly all the HTML files are integrated to form an electronic book HTML_{bk}.

The respective embodiment of the system that produces video works 100 mentioned above can be a software program stored in a non-transitory computer-readable medium. The above system that produces video works 100 is executed when the computer reads the program of the system that produces video works 100.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A system combining Augmented Reality (AR) technology with self-created elements to produce video works and being executed in an electronic computer system comprising:
a data module that stores at least one software drawing template and at least one software scene therein;
an image input module that reads a physical image corresponding to at least one physical character of a physical picture book and defines a software image border of the physical image by software technology;
a recognition and analysis module that compares the software drawing template with the software image border to obtain software drawn content; and
an integration module that fills the software drawn content into the software drawing template correspondingly for generating an AR object and integrates the AR object with the software scene for generating a self-created AR work;
wherein the physical image is at least one sketch image or at least one painting image or at least one multi medium element image.

2. The system as claimed in claim 1, wherein the software scene is constructed base on a teaching aid.

3. The system as claimed in claim 1, wherein the image input module reads the physical image by using a camera to catch a real-time image or read a physical image file.

4. The system as claimed in claim 1, wherein a file name of the software drawn content is defined by an account, a page number, a serial number, an edition number, or a combination thereof.

5. The system as claimed in claim 1, wherein a plurality of recognition points is set on the software drawing template and the physical character respectively and correspondingly.

6. The system as claimed in claim 1, wherein the system further includes a voice input module that reads a real-time speech or an audio file to generate voice content; the integration module further integrates voice content, the software drawn content with the software scene for generating the self-created AR work.

7. The system as claimed in claim 1, wherein a file name of the voice content is defined by an account, a page number, a serial number, an edition number, or a combination thereof.

8. The system as claimed in claim 1, wherein the integration module defines the respective page of a physical picture book, creates a 2D or 3D model of the software drawn content of the respective page, applies the 2D or 3D model to the software scene for providing dynamic effects, and integrates the voice content with the respective page correspondingly to generate the self-created AR work.

9. The system as claimed in claim 1, wherein the system further includes an electronic book generating module that not only uses a book as a script and AR technology to process the software drawn content, the voice content and a plurality of components predefines as the software scene of the respective page to form an AR page of the respective page, but also combines the AR pages into an AR e-book with audio formats and simple page flip effect.

10. A non-transitory computer-readable medium stores the system combining Augmented Reality (AR) technology with self-created elements to produce video works as claimed in claim 1 therein.
